(19) United States
(12) Patent Application Publication
(10) Pub. No.: US 2023/0106985 A1
(43) Pub. Date: Apr. 6, 2023

(54) DEVELOPING MACHINE-LEARNING MODELS

(71) Applicant: Telefonaktiebolaget LM Ericsson (publ), Stockholm (SE)

(72) Inventors: Wenfeng HU, TÄBY (SE); Konstantinos VANDIKAS, SOLNA (SE); Selim ICKIN, STOCKSUND (SE)

(73) Assignee: Telefonaktiebolaget LM Ericsson (publ), Stockholm (SE)

(21) Appl. No.: 17/767,688

(22) PCT Filed: Oct. 9, 2019
(86) PCT No.: PCT/SE2019/050988

§ 371 Date: Apr. 8, 2022

(51) Int. Cl. G06N 3/098

(52) U.S. Cl. CPC G06N 3/098

(57) ABSTRACT

A method (300) for using federated learning to develop a machine-learning model is disclosed. The method, performed by a management function, comprises developing a seed version of the machine-learning model using a machine-learning algorithm (310) and communicating the seed version of the machine-learning model to a plurality of distributed nodes, each of the plurality of distributed nodes being associated with a local data set (320). The method further comprises receiving, for each of the plurality of distributed nodes, a representation of distribution of data within the associated local data set (330), assigning each of the plurality of distributed nodes to a learning group on the basis of the received representations, wherein each learning group comprises a subset of the plurality of distributed nodes amongst which federated learning is to be performed (340), and obtaining at least one group version of the machine learning model for each learning group based on the node versions of the machine learning model developed by the distributed nodes in the learning group (350).

### FIELD OF THE INVENTION

Embodiments described herein relate to methods and apparatus for developing a machine-learning model.

### BACKGROUND

Conventionally, machine-learning models may be developed at a centralized network node, using a centralized data set that is available at the centralized network node. For example, a global hub of a network may comprise a global dataset that can be used to develop a machine-learning model. Typically, a large, centralized dataset is required to train an accurate machine-learning model.

However, this need for a centralized data set to train a machine learning model may be supplemented by employing distributed machine learning techniques. One example of a distributed learning technique is federated learning. By employing a distributed machine learning technique, a trained machine-learning model may continue to be trained in an edge node. This further training of the machine-learning model may be performed using a dataset that is locally available at the edge node, and in some embodiments the dataset will have been locally generated at the edge node.

Thus, distributed machine learning techniques allow updated machine-learning models to be trained at edge nodes within a network, where these updated machine-learning models have been trained using data that may not have been communicated to, and may not be known to, the centralized node (where the machine-learning model was initially trained). In other words, an updated machine-learning model may be trained locally at an edge node using a dataset that is only accessible locally at the edge node, and may not be accessible from other nodes within the network. It may be that the local set of data comprises sensitive or otherwise private information that is not to be communicated to other nodes within the network.”

Communications network operators, service and equipment providers, are often in possession of vast global datasets, arising from managed service network operation and/or product development verification. Such data sets are generally located at a global hub. Federated learning (FL) is a potential technology enabler for owners of such datasets and other interested parties to exploit the data, sharing learning without exposing raw data.

One of the challenges encountered in FL is its inherent inability to deal with unbalanced datasets, meaning that different datasets follow different distribution patterns. For example, one dataset may contain two categories with considerably more data samples in the first category than the second, while another dataset with the same categories may have a total number of data samples that is orders of magnitude fewer than the total number of samples in the first dataset. These example two datasets demonstrate imbalance both within the first dataset and between the datasets. In another example, one client may experience particular events with 1% probability, while another client might experience the same events far less frequently, with 0.01% probability. This variation within and datasets may sometimes be referred to as label distribution. This lack of balance in datasets means that the i.i.d. assumption (independent and identically distributed), relied upon for most machine learning (ML) training algorithms, is no longer valid. Ultimately this leads to the introduction and propagation of bias, thus decreasing the quality of the ML model. This limitation can potentially be exploited by malicious users (or content farmers) which can intentionally craft biased input thus off-throwing the federation process.

It will be appreciated that conventional federated learning methods, which form an updated machine-learning model based on a simple averaging of a number of node versions of a machine-learning model, may not provide an optimal solution. For example, a simple averaging of a number of node versions of a machine-learning model may introduce bias into the updated machine-learning model, as the node versions of the machine-learning model may have been developed using a number of unbalanced local data sets available at each distributed node.

### SUMMARY

It is an aim of the present disclosure to provide a method, apparatus and computer readable medium which at least partially address one or more of the challenges discussed above.

According to a first aspect of the present disclosure, there is provided a method for using federated learning to develop a machine-learning model. The method comprises, at a management function, developing a seed version of a machine-learning model using a machine-learning algorithm and communicating the seed version of the machine-learning model to a plurality of distributed nodes, each of the plurality of distributed nodes being associated with a local data set. The method further comprises, at individual nodes of the plurality of distributed nodes, generating a representation of distribution of data within the local data set associated with the distributed node, and communicating the representation of distribution of data within the associated local data set to the management function. The method further comprises, at the management function, assigning each of the plurality of distributed nodes to a learning group on the basis of the received representations, wherein each learning group comprises a subset of the plurality of distributed nodes amongst which federated learning is to be performed. The method further comprises, for at least one learning group, at each of the plurality of distributed nodes within said learning group, developing a node version of the machine-learning model, based on the seed version of the machine-learning model and the associated local data set, and using the machine-learning algorithm, and communicating a representation of the node version of the machine-learning model to the management function. The method further comprises, at the management function, obtaining at least one group version of the machine learning model for each learning group based on the node versions of the machine learning model developed by the distributed nodes in the learning group.

According to another aspect of the present disclosure, there is provided a method for using federated learning to develop a machine-learning model. The method, performed by a management function, comprises developing a seed version of the machine-learning model using a machine-learning algorithm, communicating the seed version of the machine-learning model to a plurality of distributed nodes, each of the plurality of distributed nodes being associated with a local data set, and receiving, for each of the plurality of distributed nodes, a representation of distribution of data within the associated local data set. The method further comprises assigning each of the plurality of distributed nodes to a learning group on the basis of the received representations, wherein each learning group comprises a subset of the plurality of distributed nodes amongst which federated learning is to be performed, and obtaining at least one group version of the machine learning model for each learning group based on the node versions of the machine learning model developed by the distributed nodes in the learning group.

According to another aspect of the present disclosure, there is provided a method for using federated learning to develop a machine-learning model. The method, performed by a distributed node, comprises receiving a seed version of a machine-learning model, wherein the seed version of the machine-learning model has been developed using a machine-learning algorithm, generating a representation of distribution of data within a local data set associated with the distributed node and communicating the generated representation to a management function. The method further comprises developing a node version of the machine-learning model, based on the seed version of the machine-learning model and the associated local data set, and using the machine-learning algorithm, and communicating a representation of the node version of the machine-learning model to the management function.

According to a first aspect of the present disclosure, there is provided a method for using federated learning to develop a machine-learning model. The method, performed by a group management function for a learning group, comprises receiving, from distributed nodes in the learning group, representations of node versions of a machine-learning model, wherein the node versions of the machine-learning model have been developed based on a seed version of the machine-learning model and a local data set associated with the respective distributed node, and using a machine-learning algorithm. The method further comprises combining the node versions of the machine-learning model to form a group version of the machine learning model and communicating the group version of the machine-learning model to a centralized management function.

According to a first aspect of the present disclosure, there is provided a computer program comprising instructions which, when executed on at least one processor, cause the at least one processor to carry out a method according to any one of the preceding aspects of the present disclosure.

According to a first aspect of the present disclosure, there is provided a management function for using federated learning to develop a machine-learning model. The management function comprises processing circuitry configured to cause the management function to develop a seed version of the machine-learning model using a machine-learning algorithm, communicate the seed version of the machine-learning model to a plurality of distributed nodes, each of the plurality of distributed nodes being associated with a local data set, receive, for each of the plurality of distributed nodes, a representation of distribution of data within the associated local data set, assign each of the plurality of distributed nodes to a learning group on the basis of the received representations, wherein each learning group comprises a subset of the plurality of distributed nodes amongst which federated learning is to be performed, and obtain at least one group version of the machine learning model for each learning group based on the node versions of the machine learning model developed by the distributed nodes in the learning group.

According to another aspect of the present disclosure, there is provided a management function for using federated learning to develop a machine-learning model. The management function is adapted to develop a seed version of the machine-learning model using a machine-learning algorithm, communicate the seed version of the machine-learning model to a plurality of distributed nodes, each of the plurality of distributed nodes being associated with a local data set, receive, for each of the plurality of distributed nodes, a representation of distribution of data within the associated local data set, assign each of the plurality of distributed nodes to a learning group on the basis of the received representations, wherein each learning group comprises a subset of the plurality of distributed nodes amongst which federated learning is to be performed, and obtain at least one group version of the machine learning model for each learning group based on the node versions of the machine learning model developed by the distributed nodes in the learning group.

According to another aspect of the present disclosure, there is provided a distributed node for using federated learning to develop a machine-learning model. The distributed node comprises processing circuitry configured to cause the distributed node to receive a seed version of a machine-learning model, wherein the seed version of the machine-learning model has been developed using a machine-learning algorithm, generate a representation of distribution of data within a local data set associated with the distributed node, communicate the generated representation to a management function, develop a node version of the machine-learning model, based on the seed version of the machine-learning model and the associated local data set, and using the machine-learning algorithm, and communicate a representation of the node version of the machine-learning model to the management function.

According to another aspect of the present disclosure, there is provided a distributed node for using federated learning to develop a machine-learning model. The distributed node is adapted to receive a seed version of a machine-learning model, wherein the seed version of the machine-learning model has been developed using a machine-learning algorithm, generate a representation of distribution of data within a local data set associated with the distributed node, communicate the generated representation to a management function, develop a node version of the machine-learning model, based on the seed version of the machine-learning model and the associated local data set, and using the machine-learning algorithm, and communicate a representation of the node version of the machine-learning model to the management function.

According to another aspect of the present disclosure, there is provided a group management function for using federated learning to develop a machine learning model. The group management function comprises processing circuitry configured to cause the group management function to receive, from distributed nodes in the learning group, representations of node versions of a machine-learning model, wherein the node versions of the machine-learning model have been developed based on a seed version of the machine-learning model and a local data set associated with the respective distributed node, and using a machine-learning algorithm, combine the node versions of the machine-learning model to form a group version of the machine learning model, and communicate the group version of the machine-learning model to a centralized management function

According to another aspect of the present disclosure, there is provided a group management function for using federated learning to develop a machine learning model. The group management function is adapted to receive, from distributed nodes in the learning group, representations of node versions of a machine-learning model, wherein the node versions of the machine-learning model have been developed based on a seed version of the machine-learning model and a local data set associated with the respective distributed node, and using a machine-learning algorithm, combine the node versions of the machine-learning model to form a group version of the machine learning model, and communicate the group version of the machine-learning model to a centralized management function

### BRIEF DESCRIPTION OF DRAWINGS

For a better understanding of the present invention, and to show how it may be put into effect, reference will now be made, by way of example only, to the accompanying drawings, in which:—

FIGS. 1a and 1b illustrate a flow chart showing process steps in a method for using federated learning to develop a machine-learning model;

FIGS. 2a and 2b illustrate a flow chart showing process steps in another example of method for using federated learning to develop a machine-learning model;

FIG. 3 illustrates a flow chart showing process steps in another example of method for using federated learning to develop a machine-learning model;

FIGS. 4a to 4d illustrates a flow chart showing process steps in another example of method for using federated learning to develop a machine-learning model;

FIG. 5 illustrates a flow chart showing process steps in another example of method for using federated learning to develop a machine-learning model;

FIG. 6 illustrates a flow chart showing process steps in another example of method for using federated learning to develop a machine-learning model;

FIG. 7 illustrates a flow chart showing process steps in another example of method for using federated learning to develop a machine-learning model;

FIG. 8 illustrates a flow chart showing process steps in another example of method for using federated learning to develop a machine-learning model;

FIG. 9 shows a message flow diagram illustrating example exchanges between entities according to different examples of the methods of FIGS. 1 to 8;

FIG. 10 illustrates an example communication network deployment;

FIG. 11 is a block diagram illustrating functional modules in a management function;

FIG. 12 is a block diagram illustrating functional modules in another example of management function;

FIG. 13 is a block diagram illustrating functional modules in a distributed node;

FIG. 14 is a block diagram illustrating functional modules in another example of distributed node;

FIG. 15 is a block diagram illustrating functional modules in a group management function; and

FIG. 16 is a block diagram illustrating functional modules in another example of group management function.

### DETAILED DESCRIPTION

Examples of the present disclosure provide methods for using federated learning to develop a machine learning model. The methods introduce the concept of learning groups, with individual nodes being assigned to different learning groups on the basis of representations provided by the nodes of the distribution of data within their local data sets. Individual node versions of a ML model are combined within the learning groups to form group versions of the ML model. By combining individual node versions with other members of a learning group, the learning group assembled on the basis of data distribution within local node data sets, many of the issues discussed above relating to the introduction and propagation of bias when using federated learning on unbalanced data sets can be mitigated.

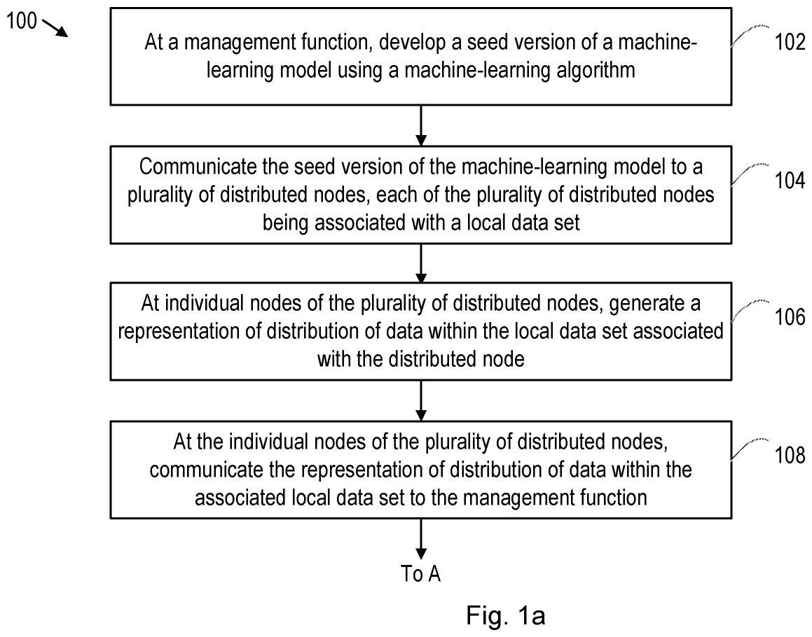

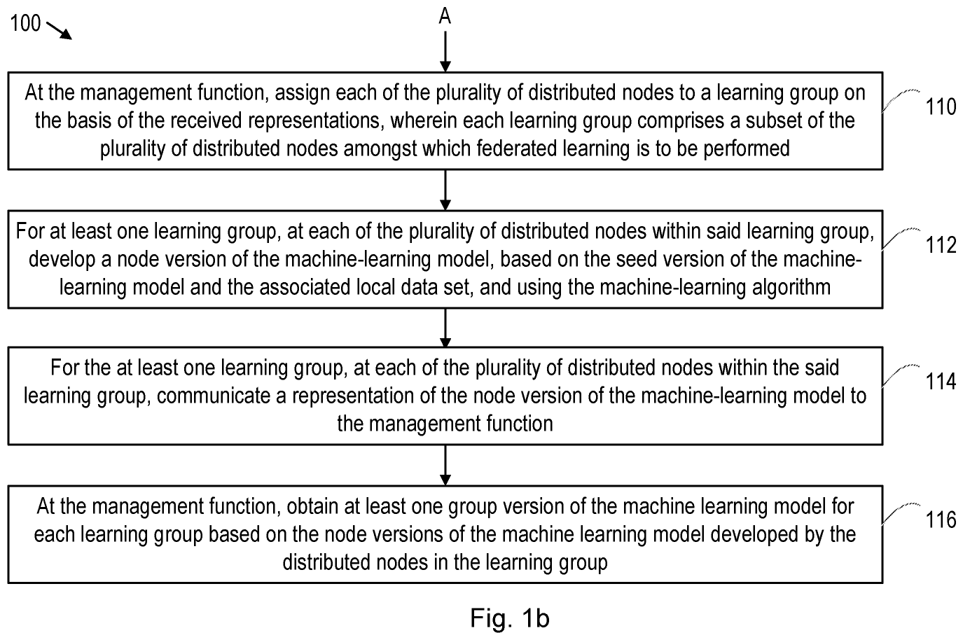

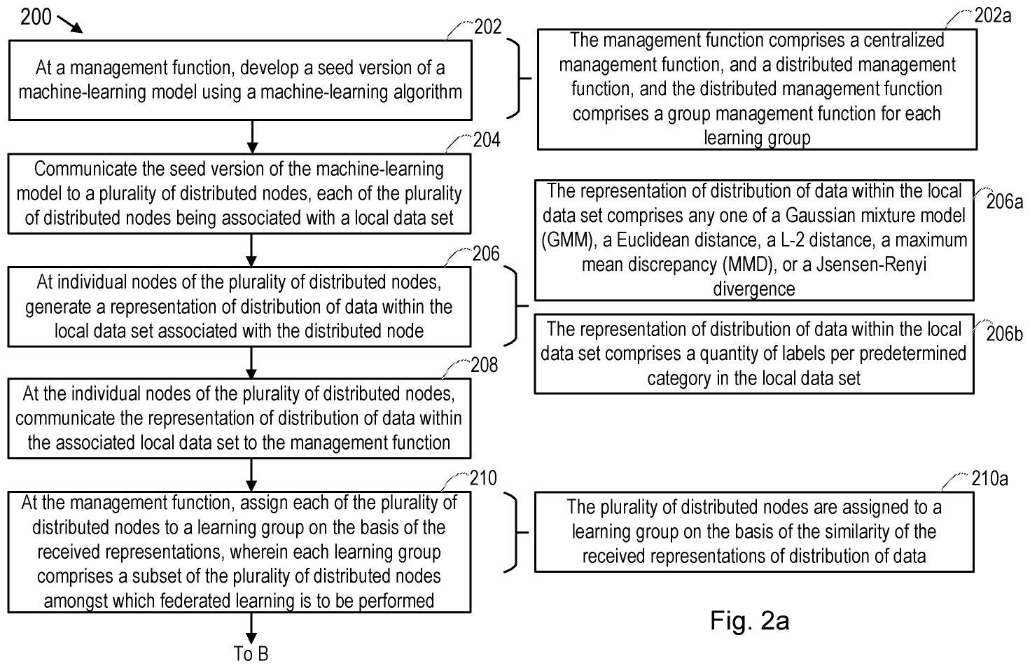

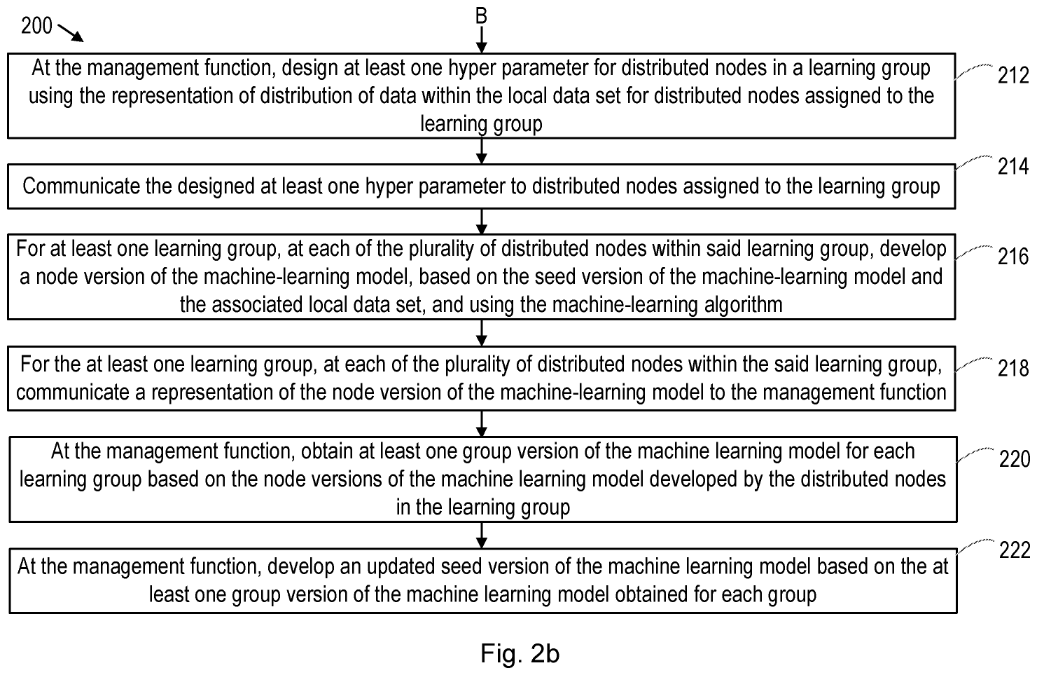

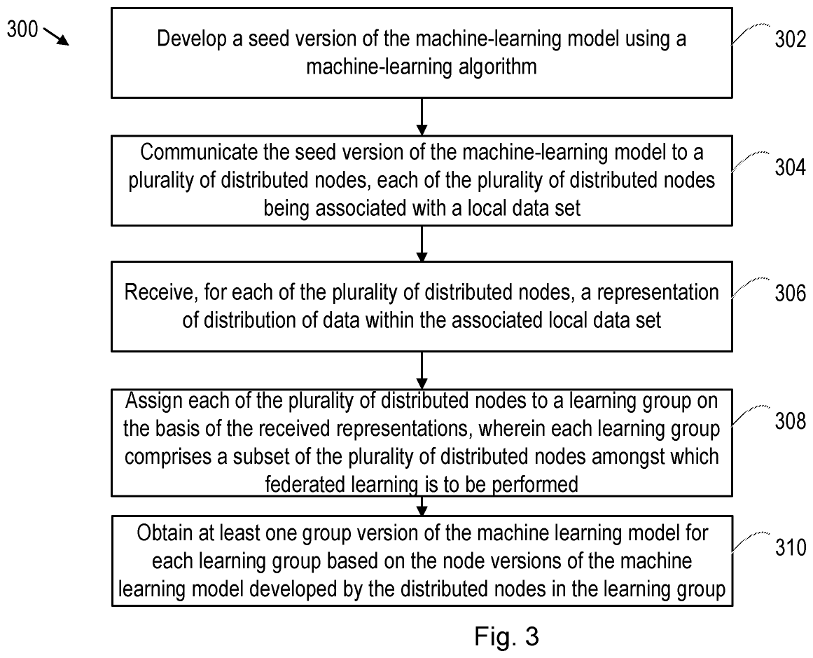

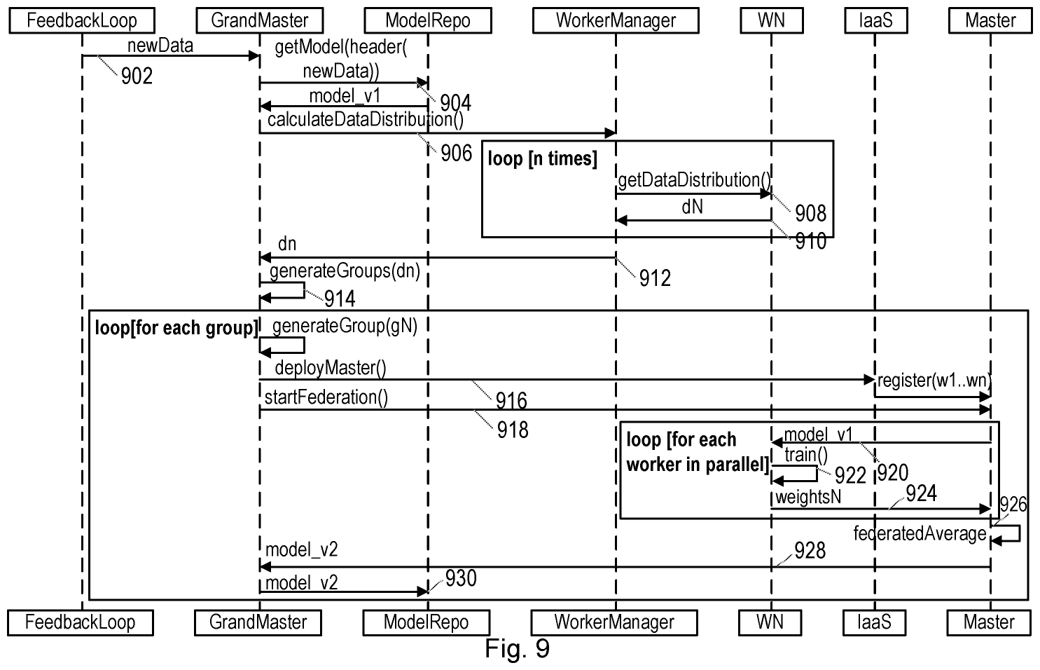

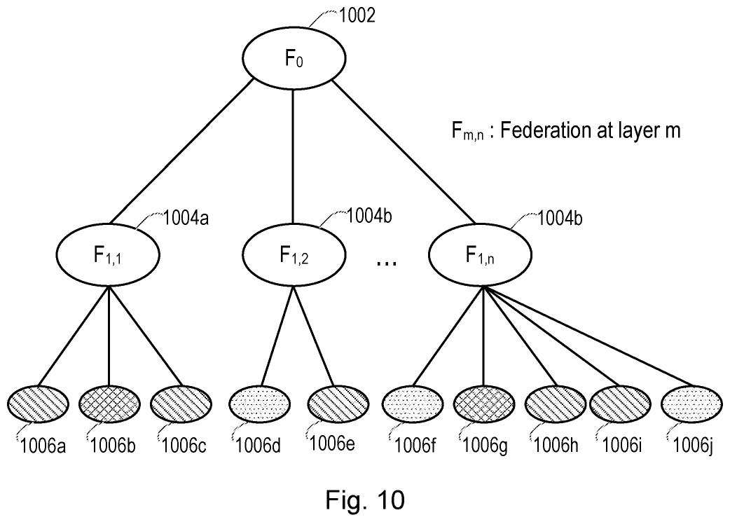

Example methods according to the present disclosure are described below. FIGS. 1a, 1b, 2a and 2b illustrate an overview of methods for generating a machine learning model using federated learning, encompassing multiple interacting entities operating together as a system. FIGS. 3 to 8 illustrate methods according to examples of the present disclosure that may be carried out at different individual entities, such that the entities cooperate to achieve the functionality discussed above. There then follows a discussion of implementation of the disclosed methods, including example use cases, with reference to FIGS. 9 and 10.

FIGS. 1a and 1b show a flow chart illustrating process steps in a method 100 for using federated learning to develop a machine-learning model. The method 100 is conducted in multiple interacting entities, including distributed local nodes and a management function. The method illustrated in FIGS. 1a and 1b may be used in the context of any kind of local dataset. However, particular advantages may be observed when the method is run using local datasets that exhibit some degree of imbalance in the data distribution of the local data sets. Such imbalance may contribute to the i.i.d. assumption, relied upon for most machine learning (ML) training algorithms, being no longer valid. Imbalance between local datasets may arise as a consequence of a wide range of factors relating to the location and nature of the local nodes at which the datasets are assembled, and individuals associated with the local nodes. Taking the example of a set of local nodes in the form of smartphones, the local dataset of a smartphone will be affected by factors relating to the smartphone user, the location of the smartphone, the applications most frequently run on the smartphone etc. A local dataset assembled by a smartphone that is only rarely used and principally for voice communication, will differ greatly in the number of data points and their distribution to that assembled by a smartphone that is used prolifically for voice and data communication, browsing, gaming etc. Examples of the present disclosure may mitigate the effects of such imbalance, as discussed in further detail below.

Referring to FIG. 1a, in a first step 102, the method 100 comprises, at a management function, developing a seed version, which may be an initialization model or initial version, of a machine-learning model using a machine-learning algorithm. The seed version of the model may comprise a version of the model that is generated using only generic or common features, wherein such features demonstrate feature distributions on individual model versions that are similar, and wherein the importance of such features on individual model versions is significant. Various machine learning algorithms may be envisaged, including for example Neural Networks. The management function may comprise any substantially centralized function. In one example, the management function may be running in a cloud environment, such as a Kubernetes® cloud. In further examples, the management function may be running on any node and/or device that supports hardware acceleration when training a machine learning model. This may include mobile phones or other hand held devices, base stations etc. The method then comprises, at step 104, communicating the seed version of the machine-learning model to a plurality of distributed nodes, each of the plurality of distributed nodes being associated with a local data set. In step 106, the method comprises, at individual nodes of the plurality of distributed nodes, generating a representation of distribution of data within the local dataset associated with the individual distributed node. The representation may be an estimation of the distribution density of the local dataset. In step 108, the method comprises, at the individual nodes of the plurality of distributed nodes, communicating the representation of distribution of data within the associated local data set to the management function.

Referring now to FIG. 1b, the method 100 further comprises, at step 110, at the management function, assigning each of the plurality of distributed nodes to a learning group on the basis of the received representations, wherein each learning group comprises a subset of the plurality of distributed nodes amongst which federated learning is to be performed. In step 112, the method comprises, for at least one learning group, at each of the plurality of distributed nodes within said learning group, developing a node version of the machine-learning model, based on the seed version of the machine-learning model and the associated local data set, and using the machine-learning algorithm. The node version of the machine-learning model is a version of the model that is unique to the node, having been developed by the node starting from the seed version of the model and using the machine-learning algorithm and the local data set associated with the node. The machine-learning algorithm may be a Neural Network. In step 114, the method comprises, for the at least one learning group, at each of the plurality of distributed nodes within the said learning group, communicating a representation of the node version of the machine-learning model to the management function. In step 116, the method comprises, at the management function, obtaining at least one group version of the machine learning model for each learning group based on the node versions of the machine learning model developed by the distributed nodes in the learning group. The group version of the machine-learning model is a version of the model that is unique to the group, having been developed by the management function by combining the node versions of the model from nodes in the learning group.

FIGS. 2a and 2b show a flow chart illustrating process steps in another example of a method 200 for using federated learning to develop a machine-learning model. The steps of the method 200 illustrate one way in which the steps of the method 100 may be implemented and supplemented in order to achieve the above discussed and additional functionality. As for the method of FIGS. 1a and 1b above, the method 200 may be conducted in a plurality of interacting entities including local nodes and a management function.

Referring to FIG. 2a, the method comprises, in step 202, at a management function, developing a seed version of a machine-learning model using a machine-learning algorithm. In some examples of the present disclosure, the seed version of the machine learning model may be developed from representations of local versions of the model. Thus, for example, following a training process conducted at distributed nodes using local datasets available at the distributed nodes, individual distributed nodes may provide to the management function representations of their local version of the model. In the case of Neural Networks, the representations may comprise the weights to be applied to individual nodes or connections in the Neural Network according to the local version of the model. The management function may then assemble the seed version of the model by aggregating the received weights or other representations. In some examples, the representations of local versions of the model may have been provided as part of an earlier iteration of the method. As illustrated in step 202a, the management function comprises a centralized management function, and a distributed management function, and the distributed management function comprises a group management function for each learning group. The centralized and distributed management functions may be instantiated at different nodes within a network. Taking the example of a communication network, the centralized management function may for example be instantiated within a core network function, and the distributed management function, comprising multiple group management functions, may be instantiated within one or more radio access nodes or edge network nodes. The local nodes may comprise individual wireless devices such as User Equipments.

In step 204, the method comprises communicating the seed version of the machine-learning model to a plurality of distributed nodes, each of the plurality of distributed nodes being associated with a local data set.

In step 206, the method comprises, at individual nodes of the plurality of distributed nodes, generating a representation of distribution of data within the local data set associated with the individual distributed node. As illustrated in step 206a, the representation of distribution of data within the local data set may comprise any one or more of a Gaussian mixture model (GMM), a Euclidean distance, a L-2 distance, a maximum mean discrepancy (MMD), or a Jsensen-Renyi divergence. As illustrated in step 206b, the representation of distribution of data within the local data set may further comprise a quantity of labels per predetermined category in the local data set. In later description of implementation of methods according to the present disclosure, the example of a representation of data distribution in the form of a GMM is used. GMMs may offer particular advantages including ease of similarity comparison.

As discussed above, the distributed nodes may be associated with data sets in which the labels describing those data sets are imbalanced, for example both the quantity of data samples and the distribution of data within the datasets may vary considerably between datasets. For example, when the distributed nodes in a network represent individual clients, the labels describing those data sets may be imbalanced over those individual clients. For example, one client may describe its data set as comprising 7000 positive samples and 3000 negative samples. It will be appreciated that such a data set may be used in a binary classification problem. In another example, a second client may describe its data set as comprising 500 positive and negative samples in total. In another example, a third client may describe its data set as comprising 30% positive and 70% negative samples. In another example, a fourth client may describe its data set as comprising 5000 positive and negative samples in total. Thus, in this example, the quantity of labels per predetermined category for the first client may comprise 7000 labels in the positive category, and may further comprise 3000 labels in the negative category.

It will be appreciated that the representation of a local dataset may comprise any one or more of a Gaussian mixture model (GMM), a Euclidean distance, a L-2 distance, a maximum mean discrepancy (MMD), or a Jsensen-Renyi divergence and a quantity of labels per predetermined category in the local data set. It will be appreciated that by communicating a representation of the local dataset that comprises a greater number of parameters, more information relating to the local data set is obtained by the management function. As a result, the management function may be able more accurately to assign each of the plurality of distributed nodes to a learning group on the basis of the received representations, as more information is available to the management function. However, it will also be appreciated that to provide this additional information to the management function may require additional computational complexity at each of the plurality of distributed nodes. The tradeoff between additional processing requirement at the local nodes and availability of additional information at the management function may be assessed on a case by case basis for individual deployments.

It will be appreciated that in comparison to a conventional federated learning process, the methods 100, 200 require the transmission from local nodes of a representation of the distribution of data within their local data sets. This maintains the privacy advantages of conventional federated learning, as the data itself is not transmitted, but facilitates the grouping of nodes into learning groups, and the development of group versions of a learning model, so mitigating the undesirable effects of imbalanced data sets.

Referring still to FIG. 2a, at step 208, the method comprises, at the individual nodes of the plurality of distributed nodes, communicating the representation of distribution of data within the associated local data set to the management function.

At step 210, the method comprises, at the management function, assigning each of the plurality of distributed nodes to a learning group on the basis of the received representations, wherein each learning group comprises a subset of the plurality of distributed nodes amongst which federated learning is to be performed. As illustrated at step 210a, the plurality of distributed nodes are assigned to a learning group on the basis of the similarity of the received representations of distribution of data. In some examples, an initial comparison may be made between data distribution in individual local data sets and data distribution in a reference data set, which may be a data set that is available to the management function. The process of assigning individual nodes to learning groups on the basis of similarity of their local data set data distribution is discussed in further detail below.

Referring now to FIG. 2b, the method 200 further comprises, at step 212, at the management function, designing at least one hyper parameter for distributed nodes in a learning group using the representation of distribution of data within the local data set for distributed nodes assigned to the learning group

In some examples, the hyper-parameters may be designed based on any of a Gaussian mixture model (GMM), a Euclidean distance, a L-2 distance, a maximum mean discrepancy (MMD), or a Jsensen-Renyi divergence describing a distribution of data. Additionally or alternatively, the hyper-parameters may be designed based on the received quantity of labels per predetermined category in the local data set. Additionally or alternatively, the hyper-parameters may be designed based on the determined similarity between the received representations of distributions of data.

For example, where the hyper-parameters are designed based on the received quantity of labels per predetermined category in the local data set, the resulting hyper-parameters may then compensate for the imbalance in the data sets between the individual distributed nodes. For example, the designed hyper-parameters for a client with a data set as comprising 7000 positive samples and 3000 negative samples, and the designed hyper-parameters for a client with a data set comprising 500 positive and negative samples in total, may compensate for both the imbalance in the size of the data sets and in the imbalance between the proportion of labels per category.

Referring still to FIG. 2b, at step 214, the method comprises communicating, by the management function, the designed at least one hyper parameter to distributed nodes assigned to the learning group.

At step 216, the method comprises, for at least one learning group, at each of the plurality of distributed nodes within said learning group, developing a node version of the machine-learning model, based on the seed version of the machine-learning model and the associated local data set, and using the machine-learning algorithm. The node version of the machine learning model is thus a version trained using the local data set available at that particular node.

At step 218, the method comprises, for the at least one learning group, at each of the plurality of distributed nodes within the said learning group, communicating a representation of the node version of the machine-learning model to the management function. The node versions may be communicated directly to centralized management function, or may be communicated to individual group management functions.

At step 220, the method comprises, at the management function, obtaining at least one group version of the machine learning model for each learning group based on the node versions of the machine learning model developed by the distributed nodes in the learning group.

At step 222, the method comprises, at the management function, develop an updated seed version of the machine learning model based on the at least one group version of the machine learning model obtained for each group.

FIG. 3 shows a flow chart illustrating process steps in a method 300 for using federated learning to develop a machine-learning model. The method 300 is performed by a management function. As discussed above, the method may be applied in the context of any kind of local data sets but may afford particular advantages in the context of local data sets that exhibit some degree of imbalance. Referring to FIG. 3, in a first step 302, the method comprises developing a seed version of the machine-learning model using a machine-learning algorithm. The method then comprises, at step 304, communicating the seed version of the machine-learning model to a plurality of distributed nodes, each of the plurality of distributed nodes being associated with a local data set. In step 306, the method comprises receiving, for each of the plurality of distributed nodes, a representation of distribution of data within the associated local data set. In step 308, the method comprises assigning each of the plurality of distributed nodes to a learning group on the basis of the received representations, wherein each learning group comprises a subset of the plurality of distributed nodes amongst which federated learning is to be performed. In step 310, the method comprises obtaining at least one group version of the machine learning model for each learning group based on the node versions of the machine learning model developed by the distributed nodes in the learning group.

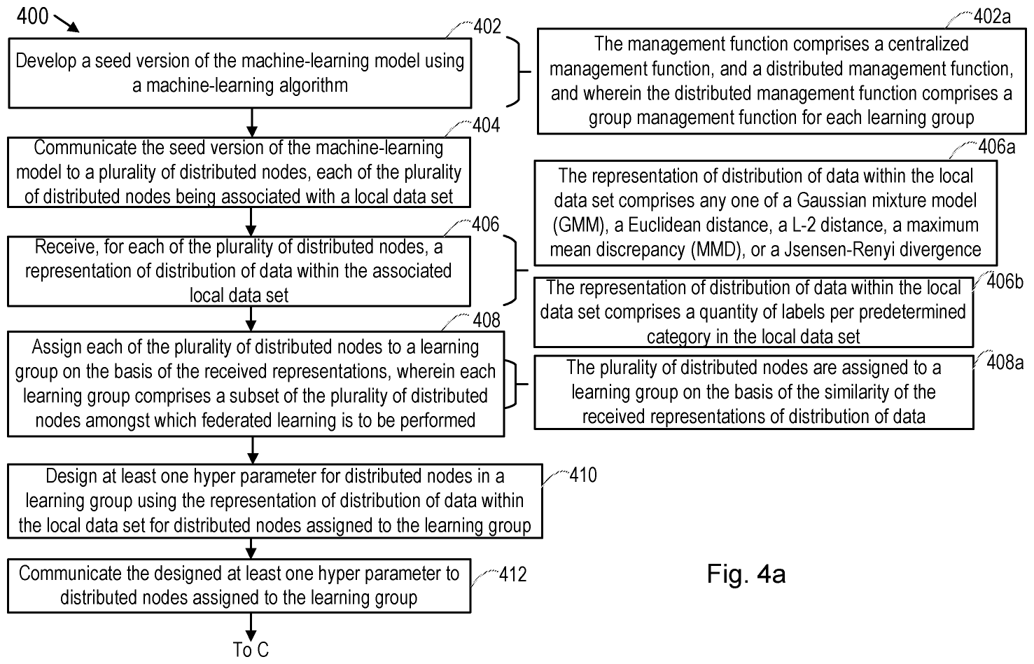

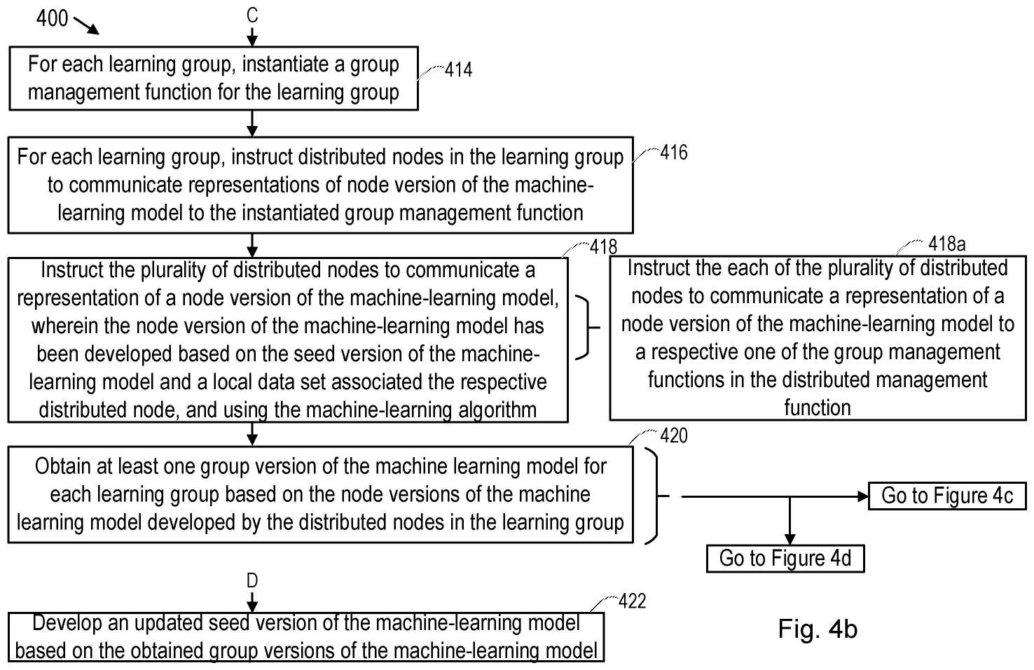

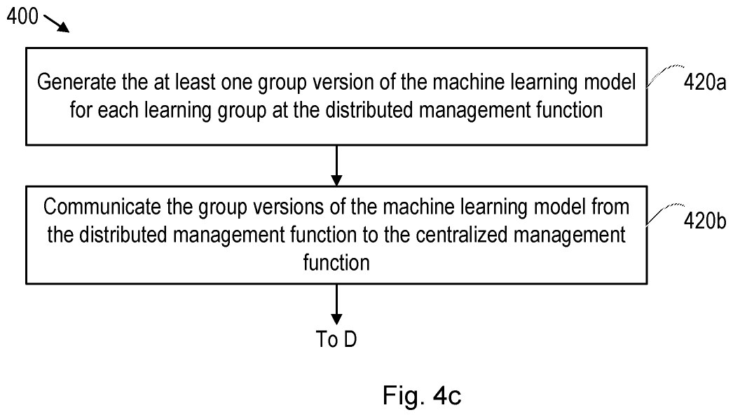

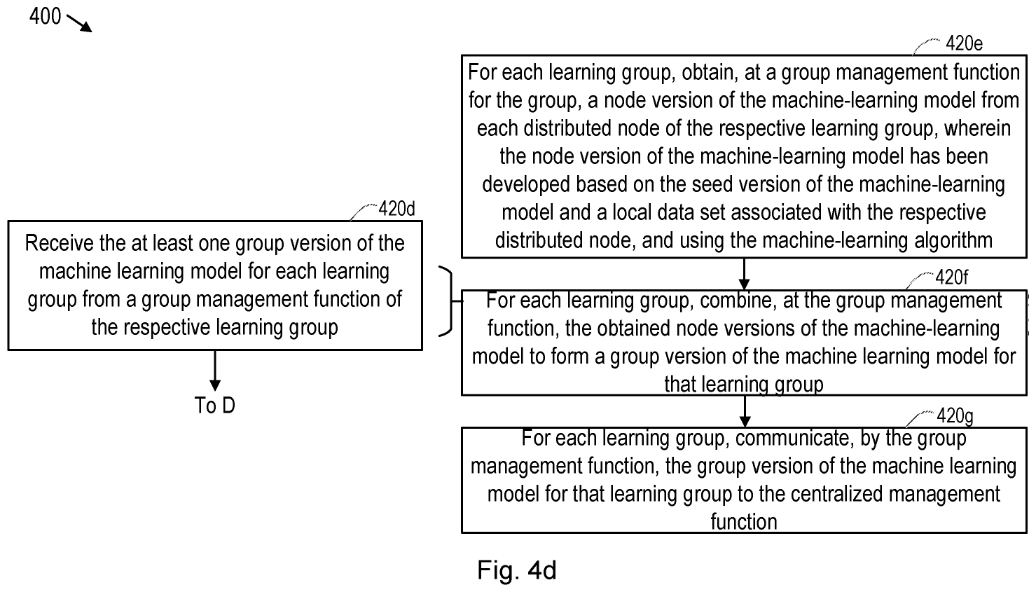

FIGS. 4a, 4b, 4c, and 4d show a flow chart illustrating process steps in another example of a method 400 for using federated learning to develop a machine-learning model, the method performed by a management function. The steps of the method 400 illustrate one way in which the steps of the method 300 may be implemented and supplemented in order to achieve the above discussed and additional functionality. The management function may be instantiated within any suitable node or entity in a network. In a 3GPP communication network, the management function may for example be instantiated within a core network function of the network. In examples in which the management function comprises both centralized and distributed elements, the centralized element may be instantiated in the core network and the distributed elements may be instantiated in the Edge network, and/or in a Radio Access network. Referring to FIG. 4a, in step 402, the method comprises developing a seed version of the machine-learning model using a machine-learning algorithm. In some examples of the present disclosure, the seed version of the machine learning model may be developed from representations of local versions of the model. Thus, for example, following a training process conducted at distributed nodes using local datasets available at the distributed nodes, individual distributed nodes may provide to the management function representations of their local version of the model. In the case of Neural Networks, the representations may comprise the weights to be applied to individual nodes or connections in the Neural Network according to the local version of the model. The management function may then assemble the seed version of the model by aggregating the received weights or other representations. In some examples, the representations of local versions of the model may have been provided as part of an earlier iteration of the method. As illustrated in step 402a, the management function may comprise a centralized management function, and a distributed management function, and the distributed management function comprises a group management function for each learning group.

In step 404, the method comprises communicating the seed version of the machine-learning model to a plurality of distributed nodes, each of the plurality of distributed nodes being associated with a local data set.

In step 406, the method comprises receiving, for each of the plurality of distributed nodes, a representation of distribution of data within the associated local data set. As illustrated in step 406a, the representation of distribution of data within the local data set may comprise any one or more of a Gaussian mixture model (GMM), a Euclidean distance, a L-2 distance, a maximum mean discrepancy (MMD), or a Jsensen-Renyi divergence. As illustrated in step 406b, the representation of distribution of data within the local data set may additionally comprise a quantity of labels per predetermined category in the local data set.

In step 408, the method comprises assigning each of the plurality of distributed nodes to a learning group on the basis of the received representations, wherein each learning group comprises a subset of the plurality of distributed nodes amongst which federated learning is to be performed. As illustrated in step 408a, the plurality of distributed nodes are assigned to a learning group on the basis of the similarity of the received representations of distribution of data. In some examples, an initial comparison may be made between data distribution in individual local data sets and data distribution in a reference data set, which may be a data set that is available to the management function. The process of assigning individual nodes to learning groups on the basis of similarity of their local data set data distribution is discussed in further detail below.

In step 410, the method comprises designing at least one hyper parameter for distributed nodes in a learning group using the representation of distribution of data within the local data set for distributed nodes assigned to the learning group.

In step 412, the method comprises communicating the designed at least one hyper parameter to distributed nodes assigned to the learning group.

Now referring to FIG. 4b, in step 414, the method comprises, for each learning group, instantiating a group management function for the learning group. In step 416, the method comprises, for each learning group, instructing distributed nodes in the learning group to communicate representations of node version of the machine-learning model to the instantiated group management function. At step 418, the method comprises instructing the plurality of distributed nodes to communicate a representation of a node version of the machine-learning model, wherein the node version of the machine-learning model has been developed based on the seed version of the machine-learning model and a local data set associated the respective distributed node, and using the machine-learning algorithm. As illustrated in step 418a, each of the plurality of distributed nodes are instructed to communicate a representation of a node version of the machine-learning model to a respective one of the group management functions in the distributed management function.

In step 420, the method comprises obtaining at least one group version of the machine learning model for each learning group based on the node versions of the machine learning model developed by the distributed nodes in the learning group. As illustrated in FIG. 4b, this step 420 may be executed in two alternative manners.

The first manner in which the step 420 of the method may be executed is illustrated at FIG. 4c. Now referring to FIG. 4c, in step 420a, the method comprises generating the at least one group version of the machine learning model for each learning group at the distributed management function. In step 420b, the method comprises communicating the group versions of the machine learning model from the distributed management function to the centralized management function. Following step 420b, the method returns to D, as illustrated in FIG. 4b.

Alternatively, the step 420 may be executed according to the method as illustrated in FIG. 4d. Now referring to FIG. 4d, in step 420d, the method comprises receiving the at least one group version of the machine learning model for each learning group from a group management function of the respective learning group. As illustrated in step 420e, the step 420d may comprise for each learning group, obtaining, at a group management function for the group, a node version of the machine-learning model from each distributed node of the respective learning group, wherein the node version of the machine-learning model has been developed based on the seed version of the machine-learning model and a local data set associated with the respective distributed node, and using the machine-learning algorithm. The method of step 420d may then comprise, as illustrated in the step 420f, for each learning group, combining, at the group management function, the obtained node versions of the machine-learning model to form a group version of the machine learning model for that learning group. The method of step 420d may then comprise, as illustrated in the step 420g, for each learning group, communicating, by the group management function, the group version of the machine learning model for that learning group to the centralized management function. Following the execution of step 420d, the method returns to D, as illustrated in FIG. 4b.

Referring again to FIG. 4b, in step 422, the method comprises developing an updated seed version of the machine-learning model based on the obtained group versions of the machine-learning model.

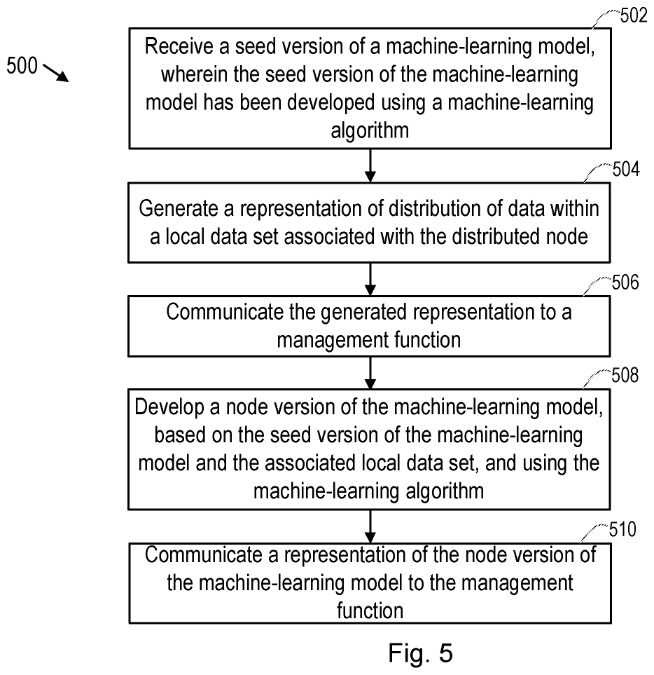

FIG. 5 shows a flow chart illustrating process steps in a method 500 for using federated learning to develop a machine-learning model, the method being performed by a distributed node. The method 500 may thus complement the methods 300, 400 described above and performed by a management function.

Referring to FIG. 5, in a first step 502, the method comprises receiving a seed version of a machine-learning model, wherein the seed version of the machine-learning model has been developed using a machine-learning algorithm, such as a neural network. The seed version of the machine-learning model may be received from a management function, as discussed above in relation to FIG. 4a. The method then comprises, at step 504, generating a representation of distribution of data within a local data set associated with the distributed node. In step 506, the method comprises communicating the generated representation to a management function. In step 508, the method comprises developing a node version of the machine-learning model, based on the seed version of the machine-learning model and the associated local data set, and using the machine-learning algorithm. In step 510, the method comprises communicating a representation of the node version of the machine-learning model to the management function.

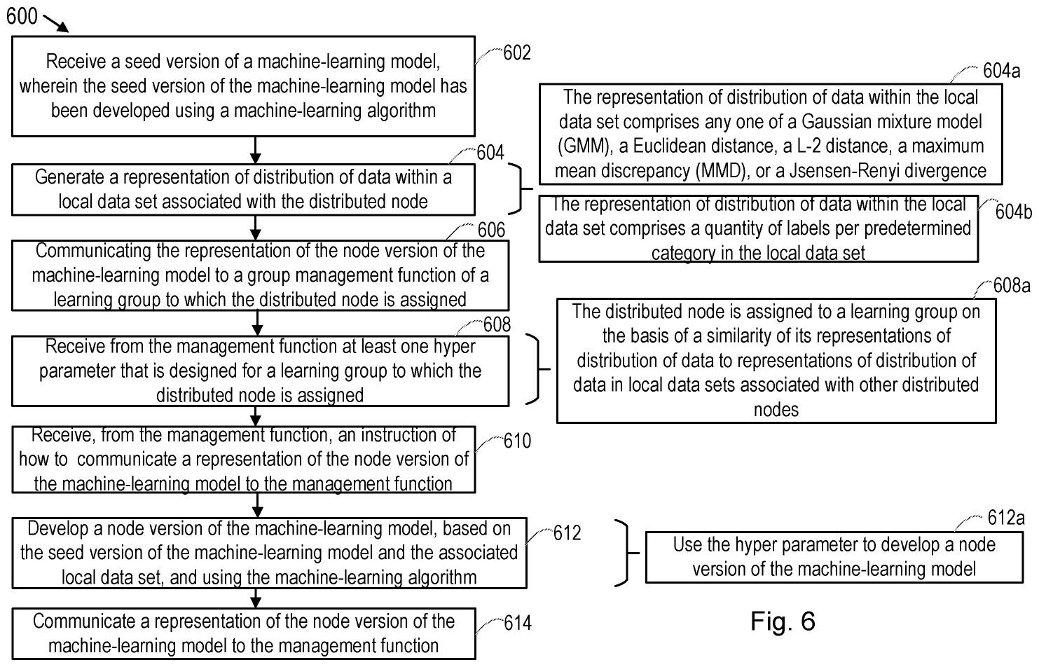

FIG. 6 shows a flow chart illustrating process steps in another example of a method 600 for using federated learning to develop a machine-learning model, the method performed by a distributed node. The steps of the method 600 illustrate one way in which the steps of the method 500 may be implemented and supplemented in order to achieve the above discussed and additional functionality. As for the method of FIG. 5 above, the method 600 may be conducted in a distributed node such as a wireless device.

Referring to FIG. 6, the method comprises, in step 602, receiving a seed version of a machine-learning model, wherein the seed version of the machine-learning model has been developed using a machine-learning algorithm.

In step 604, the method comprises generating a representation of distribution of data within a local data set associated with the distributed node. As illustrated at step 604a, the representation of distribution of data within the local data set may comprise any one of a Gaussian mixture model (GMM), a Euclidean distance, a L-2 distance, a maximum mean discrepancy (MMD), or a Jsensen-Renyi divergence. As illustrated at step 604b, the representation of distribution of data within the local data set may comprise a quantity of labels per predetermined category in the local data set.

In step 606, the method comprises communicating the representation of the node version of the machine-learning model to a group management function of a learning group to which the distributed node is assigned.

In step 608, the method comprises receiving from the management function at least one hyper parameter that is designed for a learning group to which the distributed node is assigned. As illustrated in step 608a, the distributed node is assigned to a learning group on the basis of a similarity of its representations of distribution of data to representations of distribution of data in local data sets associated with other distributed nodes.

In step 610, the method comprises receiving, from the management function, an instruction of how to communicate a representation of the node version of the machine-learning model to the management function. This may include the address or other identifier of a group management function for the learning group to which the node has been assigned.

In step 612, the method comprises developing a node version of the machine-learning model, based on the seed version of the machine-learning model and the associated local data set, and using the machine-learning algorithm. As illustrated in step 612a, the received at least one hyper parameter may be used in developing the node version of the machine-learning model.

In step 614, the method comprises communicating a representation of the node version of the machine-learning model to the management function.

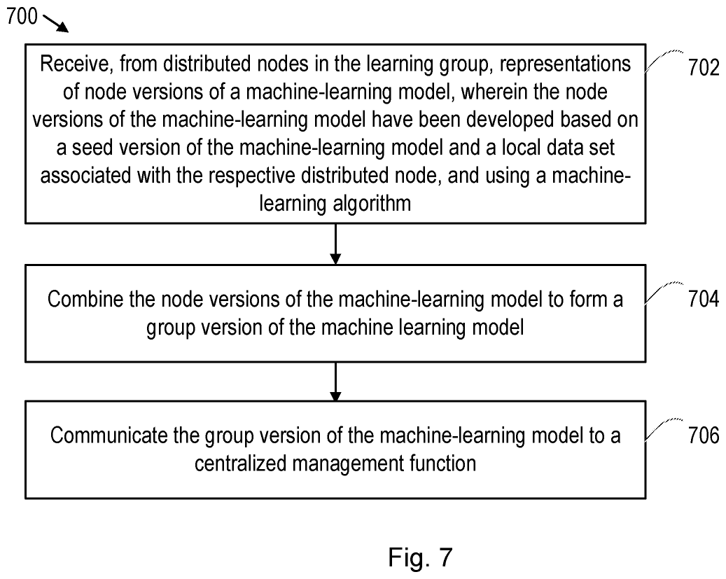

FIG. 7 shows a flow chart illustrating process steps in a method 700 for using federated learning to develop a machine-learning model, the method performed by a group management function for a learning group. As discussed above, a group management function for a learning group may comprise a distributed part of a management function that may perform the methods 300, 400. In other examples, a group management function may comprise a separate management function that is distinct from a centralized management function that is performing the method 300 and/or 400. In such examples, the group management function may perform a method 700, as discussed below.

Referring to FIG. 7, in a first step 702, the method 700 comprises receiving, from distributed nodes in the learning group, representations of node versions of a machine-learning model, wherein the node versions of the machine-learning model have been developed based on a seed version of the machine-learning model and a local data set associated with the respective distributed node, and using a machine-learning algorithm. The method then comprises, at step 704, combining the node versions of the machine-learning model to form a group version of the machine learning model. In step 706, the method comprises, communicating the group version of the machine-learning model to a centralized management function.

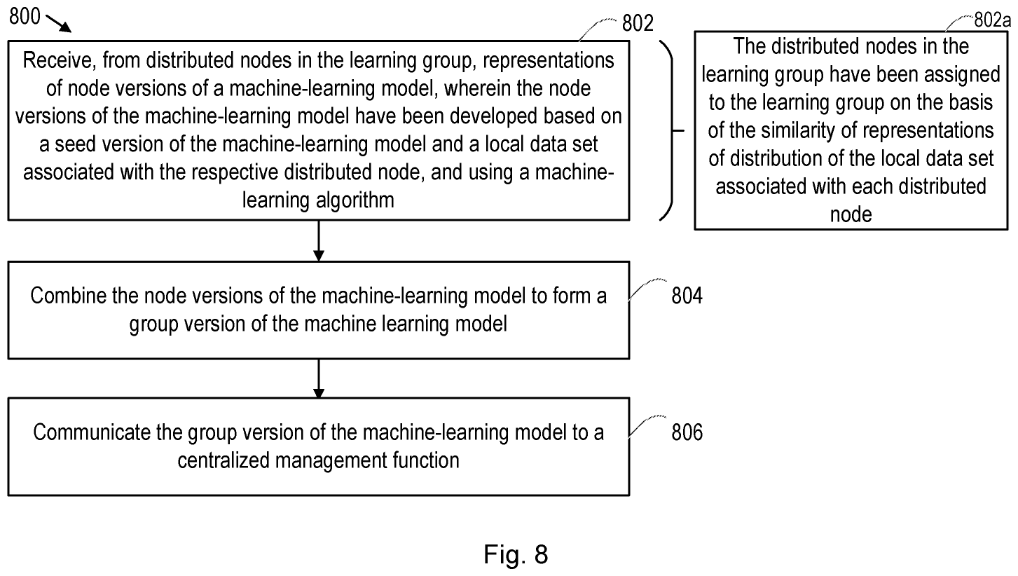

FIG. 8 shows a flow chart illustrating process steps in another example of a method 800 for using federated learning to develop a machine-learning model, the method performed by a group management function for a learning group. The steps of the method 800 illustrate one way in which the steps of the method 700 may be implemented and supplemented in order to achieve the above discussed and additional functionality.

Referring to FIG. 8, the method comprises, in step 802, receiving, from distributed nodes in the learning group, representations of node versions of a machine-learning model, wherein the node versions of the machine-learning model have been developed based on a seed version of the machine-learning model and a local data set associated with the respective distributed node, and using a machine-learning algorithm. As illustrated at step 802a, the distributed nodes in the learning group have been assigned to the learning group on the basis of the similarity of representations of distribution of the local data set associated with each distributed node.

In step 804, the method comprises combining the node versions of the machine-learning model to form a group version of the machine learning model.

In step 806, the method comprises communicating the group version of the machine-learning model to a centralized management function.

The methods 100 to 800 discussed above illustrate different ways in which a management function and a plurality of distributed nodes may cooperate to use federated learning to develop a machine learning model.

FIG. 9 shows a message flow diagram illustrating example exchanges between entities according to different examples of the methods discussed above. FIG. 9 illustrates a Grand Master node as an example of a centralized management function, a Worker Manager node as an example of a distributed management function, a plurality of Worker Nodes as an example of plurality of distributed nodes, and a Master node as an example of a group management function. The Master node may be comprised within the Worker Manager node.

Referring to FIG. 9, the Grand Master node firstly receives a data set in step 902, illustrated as new Data, from a FeedbackLoop. The FeedbackLoop is a function able to monitor whether or not new labels have been generated for dataset(s) that are being used for training. The FeedbackLoop may run either on devices, or in a cloud, and there may be either an individual notification per device, or an aggregated notification from one or more devices. In some examples, the FeedbackLoop may additionally orchestrate the Federated Learning process. The FeedbackLoop may in such examples comprise a function within a machine-learning model life-cycle management system that is operable to detect degrading of model performance and to trigger federated learning to train and/or retrain the model. After receiving new data from the FeedbackLoop, the GrandMaster then develops a seed version of a machine-learning model, based on the received data set and using a machine-learning algorithm such as Neural Networks. As discussed above, the seed version of the machine learning model may be based on representations of local versions of the machine learning model received from Worker nodes. The seed version may be based on representations that are common to all or a majority of Worker nodes, such that the seed version in effect represents a “greatest common denominator” version of the model.

The seed version of the machine-learning model is then passed to a model repository (modelRepo) in step 904. The model repository may be configured to communicate with one or more of the Grand Master node (GrandMaster), the Worker manager node (WorkManager), one or more of the plurality of distributed nodes (i.e. represented as Worker Node, WN), and/or the Master node.

The Grand Master node then communicates a request to the Worker Manager node in step 906, requesting the Worker Manager node to instruct each Worker Node to communicate a representation of distribution of data within a local data set associated with each Worker Node.

The Worker Manager node then instructs each Worker Node for which it has management responsibility to communicate a representation of distribution of data within a local data set associated with each Worker Node in step 908. Each Worker Node may then generate a representation of distribution of data within the local data set associated with that Worker Node.

Each Worker Node then communicates the representation of distribution of data within the associated local data set to its Worker Manager in step 910, and the Worker Manager forwards this information to the Grand Master node in step 912.

The Grand Master Node then assigns each of the Worker Nodes to a learning group in step 914 on the basis of the received representations. Each learning group comprises a subset of the Worker Nodes amongst which federated learning is to be performed. An algorithm for generating learning groups is discussed in further detail below.

The following steps are then executed for at least one of the learning groups that the Grand Master Node has assigned a subset of the Worker Nodes to.

The Grand Master node assigns a Master Node for the learning group. The Master Node may be instantiated within a Worker Node that is comprised within the learning group, or within a Worker Node that is not comprised within the learning group, or may be any other suitable node or management function. The Master node may for example be instantiated within a Worker Manager. The Master Node may be instantiated via an instruction to an Infrastructure as a Service (IaaS) platform in step 916.

The Grand Master node then instructs the newly instantiated Master node to begin federated learning in the group in step 918. The Master node instructs each Worker Node within the learning group to develop a node version of the machine-learning model in step 920. Each Worker Node then develops a node version of the machine-learning model in step 922, based on the seed version of the machine-learning model and the local data set associated with that Worker Node, and using the machine-learning algorithm.

Each Worker Node within the learning group then communicates a representation of the node version of the machine-learning model to the Master node in step 924. For example, in the case of a Neural Network machine learning model, the representation of a node version of the machine-learning model may comprise one or more weights to be applied to individual nodes in the neural network according to the node version of the model. Other representations may be envisaged for other kinds of machine learning model.

The Master Node then combines the obtained node versions of the machine-learning model to form a group version of the machine learning model for the learning group in step 926. For example, the Master node may average each of the obtained node versions of the machine-learning model to form the group version of the machine-learning model.

The Master Node then communicates a representation of the group version of the machine learning model for the learning group to the Grand Master node in step 928. For example, the representation of the group version of the machine learning model may comprise encrypted weightings of the node versions of the machine-learning model.

Additionally or alternatively, the representation of the group version of the machine learning model may comprise performance information corresponding to the group version of the machine learning model.

It will be appreciated that these aforementioned steps may be repeated for each learning group. Thus, the Grand Master node obtains at least one group version of the machine learning model for each learning group based on the node versions of the machine learning model developed by the Worker Nodes in each learning group.

The Grand Master node then communicates the representation of the group version of the machine-learning model to the Model Repository in step 930. The Grand Master node may additionally develop an updated seed version of the model by combining the different group versions of the model. This updated seed version may also be transferred to the model repository.

It will be appreciated that the Grand Master node may be used to monitor the different federation tasks. The method as initially executed by the Grand Master may be triggered on demand, for example, by a user of the network. Alternatively or additionally, the Grand Master may execute the method in response to a request by the Worker Manager node, one of the Worker Nodes, or the Master Node. This request may be sent to the Grand Master node upon the collection of additional data at one of the Worker Nodes.

It will be appreciated that the learning groups may represent ad-hoc graphs of the Worker Nodes that describe similarities in the data sets of the Worker Nodes in that learning group. Thus, it will be appreciated that the learning groups represent groups of Worker Nodes that may form appropriate federation groups. One or more of a group version or an updated seed version of the machine learning model may be provided to the Worker Nodes to enable learning obtained from different nodes within the learning group or within other learning groups to be used at the Worker Nodes.

Examples of the present disclosure thus facilitate the automatic generation of a graph for federated learning in a data-driven fashion by detecting the data distribution found in each dataset, and creating ad-hoc federations by grouping nodes associated with datasets having similar distribution within the same federation. In some examples, the grouping may involve an initial comparison between data distribution in individual local data sets and data distribution in a reference data set, which may be a data set that is available to the Grand Master node. Learning from distributed datasets is performed though federated learning in the learning groups, wherein members of a learning group are associated with local datasets having similarity in their data distributions.

In an example implementation, it may be envisaged that three clients would like to trigger training a machine learning model for a specific use case. In a preparation phase, each of the clients uploads the quantity of labels per category as well as distribution density estimation of their datasets. This statistical information is then used to design a federated training strategy at a centralised management function. Federated learning in learning groups is triggered, and encrypted model weights and performance are returned by individual nodes, to be combined in group versions of the machine learning model for each learning group. Subsequent rounds of decentralised batch training are then triggered until one or more convergence criteria are satisfied. Once convergence has been achieved, the model may be deployed into an inference phase. At any time, a new client may join the federated learning and begin a new process, and existing clients may trigger retraining owing to the availability of new data or model performance degradation. Model training and life cycle management may thus be achieved in a federated fashion.

The following algorithm, Algorithm 1, may be used to implement the statistic gathering and training on distributed nodes according to examples of the above discussed methods 100 to 800.

| | Algorithm 1 Statistic gathering and training on distributed clients |
|---|---|
| 1: | Input: Dataset Dₖ = {x₁, x_{2,}...,xₘₖ} where mₖ is number of |
| | samples for client k, [symbol] D₀ is global dataset where others |
| | are distributed datasets |
| 2: | for client X = 0,1,2,...K do [symbol] Statistic gathering for |
| | K+1 clients |
| 3: | Gather quantity of labels qₖ per category |
| 4: | Train a Gₖ(x) = Σᵢ₌₁^{gk} αᵢN(x\|μₖᵢ, Σ_{k,}) to approximate Dₖ, where |
| | gₖ is the number of Gaussian components |
| 5: | Upload dataset representation Cₖ = [qₖ, Gₖ(x)) to the global server |
| 6: | end for |
| 7: | /* Decentralized training for N federated learning groups*/ |
| 8: | for u=0,1,....N-1 do |
| 9: | Each client within group n receive hyper-parameters from |
| | global server |
| 10: | Federated learning between clients within group n |
| 11: | end for |

In the above algorithm, the global dataset D₀ is a reference dataset that is available to the management function. This may be a relatively large dataset that is held at a centralized location. According to the above algorithm, for each client, a quantity of labels per category of the local data set distribution is obtained, and a Gaussian mixture model of the data set distribution is obtained. In this example, the representation of the data distribution therefore comprises the quantity of labels per category and the Gaussian mixture model. However, it will be appreciated that the representation of the data distribution may comprise any suitable parameters or descriptors.

In this example, each client within a learning group receives hyper-parameters from the global server, the hyperparameters being appropriate for the learning group to which the client belongs. The hyperparameters may include particular features which are generic to all members of all learning groups, features which are generic to all members of the learning group to which the client belongs, and/or features which are specific to the client.

The following algorithm, Algorithm 2, may be used to implement the assigning of distributed nodes to federated learning groups in a management function.

| | Algorithm 2 Smart aggregationon in global training agent |
|---|---|
| 1: | Input: Cₖ, distance threshold δ, ϵ |
| 2: | Output: N trained neuraul network models Mₙ |
| 3: | for clients k=1,2,...K do |
| 4: | if d_{0,k} = dist(G₀(x), Gₖ(x)) < δ then |
| 5: | Add clients k to the FL₀ [symbol] Federated learning group 0 |
| 6: | else |
| 7: | Assign client k to training set S |
| 8: | end if |
| 9: | end for |
| 10: | for client n ϵ S do [symbol] Size of S is N-1 |
| 11: | for client k=1,2,...K do |
| 12: | if d_{n,k} = dist(Gₙ(x), Gₖ(x)) < ϵ then |
| 13: | Add clients k to the FL₁ [symbol] Federated learning group n |
| 14: | end if |
| 15: | end for |
| 16: | end for |
| 17: | /* Design training strategy for federated learning N groups */ |
| 18: | for n = 0,1,...N-1 do |
| 19: | Design training hyper-parameters using qₖ per client k within the |
| | group |
| 20: | Distribute the hyper-parameters to each client within the group |
| 21: | Initiate Mₙ and run federated learning over clients till convergence |
| 22: | end for |

It will be appreciated that there are many ways to measure the distance between two GMMs, including for example Euclidean distance, maximum mean discrepancy (MMD) or Jsensen-Renyl distance. For simplicity, L-2 distance could be used, as there is a closed-form solution.

In the above algorithm, the data distribution of the reference data set D₀ is used as a baseline for comparison in order to design federation group 0. In some implementations, it may be assumed that the reference data set D₀, being available to the management function, may be comparatively large, and may be reasonably representative of the problem that the machine learning model being developed is seeking to address. By changing the hyper-parameter delta in the above algorithm, a size of federated learning group) can be set, with G0(x) as the leader of the group.

For each of the learning groups, training hyper-parameters are designed using the received quantity of labels per category for each of the clients comprised within the learning group. The hyper-parameters are then distributed to each client within the learning group.

FIG. 10 illustrates an example communication network deployment and demonstrates how centralised and distributed management functions may manage federated learning according to examples of the present disclosure. As depicted in FIG. 10, the an example communication network comprises a Grand Master node 1002 at hierarchical level 0, three Master nodes 1004a, 1004b and 1004c at hierarchical level 1, and a plurality of distributed nodes 1006a-1006j at hierarchical level 2. The topology of the network is such that distributed nodes 1006a to 1006c are under the control of Master node 1004a, distributed nodes 1006d and 1006e are under the control of Master node 1104b, and distributed nodes 1006f to 1006j are under the control of Master node 1004c. The distributed nodes are the nodes that collect local data, develop local node versions of the machine learning model, and run inference on the collected local data using an appropriate group version of the machine-learning model. Local machine learning models in this context are trained via Federated Learning

Although the network topology illustrated in FIG. 10 comprises three hierarchical levels, it will be appreciated that the hierarchy of the network can be extended to any suitable hierarchical complexity.

FIG. 10 depicts the distributed nodes 1106a, 1106c, 1106e, 1106h and 1106i in a first learning group, the distributed nodes 1106d, 1106f and 1106j in a second learning group, and the distributed nodes 1106b and 1106g in a third learning group. It will be appreciated that although the distributed nodes are arranged into three distinct topological groups, these groups do not necessarily correspond to the determined learning groups, which represent similarity in the local data sets which are available at each of the distributed nodes. As noted above, this similarity may be characterised by similarities in the data set distributions available at each distributed node. Additionally or alternatively, this similarity may be characterised by a quantity of labels per category of the data set distributions available at each distributed node.

In some examples of the present disclosure, the Grand Master node may store a set of descriptor parameters for each distributed node. The descriptor parameters may be computed using the received representations of the data set distributions received from each distributed node.

For example, the Grand Master node may store, for each distributed node, an identifier and address of the distributed node. For example, the identifier and address may be used for communication purposes and for storage purposes. The Grand Master node may also store a federation group ID. The federation group ID may identify the learning group to which the distributed node has been assigned. As noted above, the learning groups may represent similarity in the received representations of the data set distributions from the distributed nodes in that learning group. It will be appreciated that the distributed nodes that are assigned to the same learning group are considered to comprise more similar data sets than distributed nodes that have been assigned to different learning groups. The Grand Master node may also store a plurality of model hyperparameter names for each distributed node, which are then able to be mapped to a corresponding hyperparameter value for each distributed node. The Grand Master node may also store a plurality of unused features for each distributed node. These unused features may be features that have been determined to be non-generic and highly specific to the distributed node. The above discussed information may be stored by the Grand Master node in a dictionary having the following structure:

```
{
  nodename:
    {
    fid: fid_value ,
    generic_model_parameters: [{parameter_name: parameter_value},...],
    unused_feats:[ ]
  }
}
```

Where,

Nodename: the identifier and address of the node to be for instance used in the communication and storage. Nodename is mapped to a JSON list containing the following JSON objects:

fid: federation group id such that after the similarity computation, every node is assigned to one fid. The nodes that are mapped to the same fid are considered to be more similar to each other than the ones that are mapped to other fid's.

generic_model_parameters: contains a list of JSON objects, where each JSON object is a model hyperparameter name that is mapped to the corresponding hyperparameter value.

unused_feats: unused features in the generic model consists of a list of unused features that are found to be non-generic and highly specific to individual nodes.

It is an aim when developing machine learning models to develop them such that they are as generic and representative as possible, as machine learning models have tendency to bare bias. One method of tackling the problem of introducing bias in machine learning models is by training the machine learning model using a dataset that comprises generic features. This is particularly important within federated learning methods. For example, in conventional federated learning methods, a flat averaging may be applied over a number of node versions of a machine learning model, where each node version of the machine learning model has been trained using a local dataset that is associated with a particular distributed node. This flat averaging does not account for any dissimilarity in these local datasets, and may introduce noise into the averaged model formed at the Master node. Examples of the present disclosure address this through the use of learning groups, in which nodes are assigned on the basis of the similarity of data distribution in their local data sets.

In order to assist in overcoming bias from individual data sets, common features comprised within the local datasets, and specific features comprised within the local datasets, may be distinguished from one another. Common features may comprise features that appear to contribute to a machine-learning model as generated using a local dataset available at a particular distributed node in a similar and expected manner for all machine-learning models as generated at any of the distributed nodes.

In a communication network example, an abnormal increase in battery temperature (such as overheating) in a base station or other processing unit may degrade the performance of the base station or processing unit, as the CPU utilization is degraded. Assuming that this cause and effect relationship is expected in every computing machine or hardware associated with the base station or processing unit by design, “battery temperature” may be considered a generic feature. In another example, some features may be highly geographically or socio-economically related. Age is an example of such a feature. For example, while in some countries the working population may be dominated by individuals in the age range 30-40 years, in other parts of the world this age range can be 40-50 years. Therefore, the distribution of the age of individuals in a data set, and its correlation to working individuals, may be different in two different geographical locations. Thus, the age of a user can be considered to be a specific feature in this use case. It will be appreciated that the choice of generic and specific features will be highly dependent on a use case.

In one example, generic and specific features may be obtained according to examples of the present disclosure based on the similarity calculation (which may be performed by the centralised management function, or Grand Master node). The Grand Master node may then develop a seed version of the machine-learning model using a machine-learning algorithm, and using the obtained generic features where generic features show similar distribution and also similar correlation with a target variable. This model may then be communicated to each of the distributed nodes. In other words, the specific features, which may be considered to correspond to features which are not similar across the local datasets of the distributed nodes, may not be used to develop a seed version of the machine-learning algorithm.

The Grand Master node may then notify each of the distributed nodes which features are considered to be specific features.

Thus, when each of the plurality of the distributed nodes develops a node version of the machine-learning model, based on the seed version of the machine-learning model and the local data set associated with that distributed node, and using the machine-learning algorithm, the distributed nodes may also use the specific features available at that node when developing the node version of the machine-learning model.

It will be appreciated that each of the plurality of distributed nodes will be aware of the features that have been used to develop the seed version of the machine-learning model. It will also be appreciated that the distributed nodes may develop a node version of the machine-learning model based on any suitable combination of the general features and the specific features that are available at that distributed node. For example, a distributed node may develop a node version of the machine-learning model based on the specific features available at that distributed node, and using the machine-learning algorithm.

In some embodiments, model stacking may be applied by a distributed node during model inference. Model stacking may comprise forming a stacked model based on the seed version of the machine-learning model, and the node-version of the machine-learning model that is available at that distributed node. In some examples, the stacked model may be formed at a distributed node by combining weighted versions of the seed version of the machine-learning algorithm, and the node version of the machine-learning algorithm available at that distributed node. In some examples, the weightings may be determined by using a suitable algorithm. In other examples, the weightings may be determined by using a trial and error technique. In some examples, the trial and error technique may attempt to balance both the accuracy of the output of the stacked machine-learning model, and the element of bias introduced into the stacked learning model. In other words, the trial and error technique attempts to avoid overfitting the resulting stacked machine learning model. For example, bias may be introduced into the stacked learning model as a result of including a node version of the machine learning model in the stacked learning model that has been trained on a dataset that is specific to one distributed node. In some examples, the execution of a stacked model may result in improved performance at a distributed node, when compared to the execution of either the seed version of the machine-learning model, or the node version of the machine-learning model, at the distributed node. In further examples, a tendency to bias may be mitigated according to examples of the present disclosure by stacking a group version of the model with the seed version.

As discussed above, the methods 300 to 800 may be performed by management functions or distributed nodes. The present disclosure provides a management function, a distributed node and a group management function which are adapted to perform any or all of the steps of the above discussed methods.

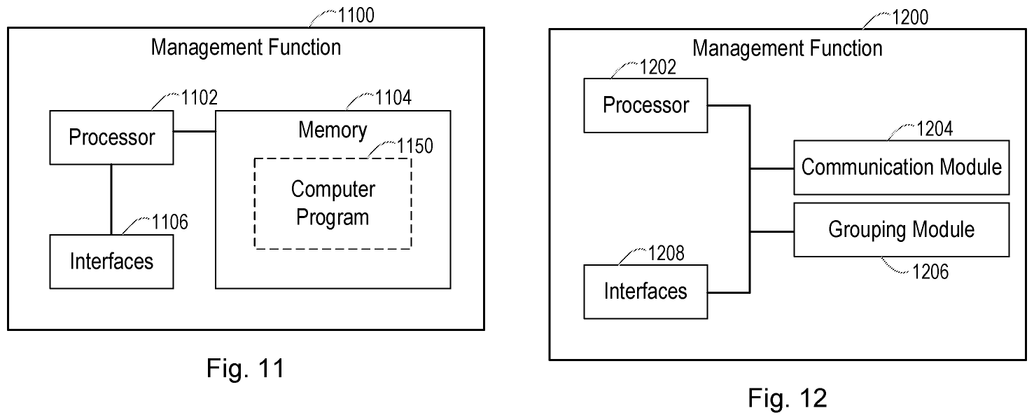

FIG. 11 is a block diagram illustrating an example management function 1100 which may implement the method 300 and/or 400 according to examples of the present disclosure, for example on receipt of suitable instructions from a computer program 1150. Referring to FIG. 11, the management function 1100 comprises a processor or processing circuitry 1102, and may comprise a memory 1104 and interfaces 1106. The processing circuitry 1102 is operable to perform some or all of the steps of the method 300 and/or 400 as discussed above with reference to FIGS. 3 and 4. The memory 1104 may contain instructions executable by the processing circuitry 1102 such that the management function 1100 is operable to perform some or all of the steps of the method 300 and/or 400. The instructions may also include instructions for executing one or more telecommunications and/or data communications protocols. The instructions may be stored in the form of the computer program 1150. In some examples, the processor or processing circuitry 1102 may include one or more microprocessors or microcontrollers, as well as other digital hardware, which may include digital signal processors (DSPs), special-purpose digital logic, etc. The processor or processing circuitry 1102 may be implemented by any type of integrated circuit, such as an Application Specific Integrated Circuit (ASIC), Field Programmable Gate Array (FPGA) etc. The memory 1104 may include one or several types of memory suitable for the processor, such as read-only memory (ROM), random-access memory, cache memory, flash memory devices, optical storage devices, solid state disk, hard disk drive etc.

FIG. 12 illustrates functional units in another example of management function 1200 which may execute examples of the methods 300 and/or 400 of the present disclosure, for example according to computer readable instructions received from a computer program. It will be understood that the units illustrated in FIG. 12 are functional units, and may be realised in any appropriate combination of hardware and/or software. The units may comprise one or more processors and may be integrated to any degree.

Referring to FIG. 12, the management function 1200 comprises a learning module 1202 for developing a seed version of the machine-learning model using a machine-learning algorithm, and a communication module 1204 for communicating the seed version of the machine-learning model to a plurality of distributed nodes, each of the plurality of distributed nodes being associated with a local data set. The communication module 1204 is also for receiving, for each of the plurality of distributed nodes, a representation of distribution of data within the associated local data set. The management function 1200 further comprises a grouping module 1206 for assigning each of the plurality of distributed nodes to a learning group on the basis of the received representations, wherein each learning group comprises a subset of the plurality of distributed nodes amongst which federated learning is to be performed, and for obtaining at least one group version of the machine learning model for each learning group based on the node versions of the machine learning model developed by the distributed nodes in the learning group. The management function 1200 may also comprise interfaces 1208.

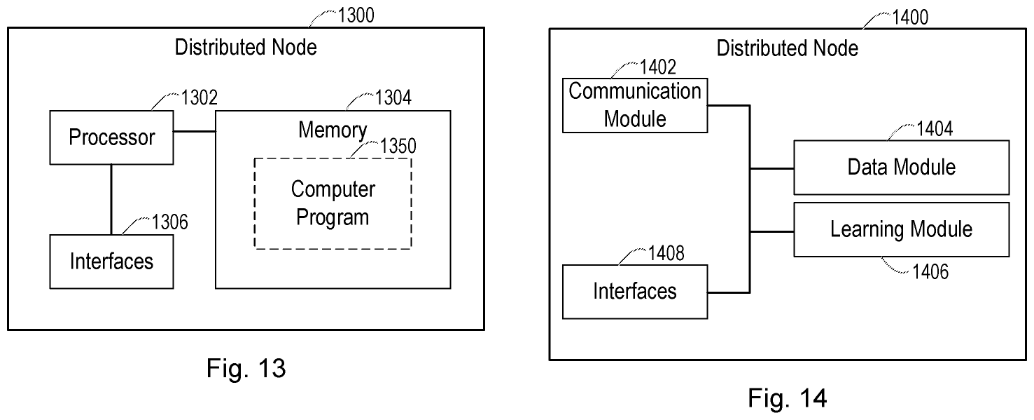

FIG. 13 is a block diagram illustrating an example distributed node 1300 which may implement the method 500 and/or 600 according to examples of the present disclosure, for example on receipt of suitable instructions from a computer program 1350. Referring to FIG. 13, the distributed node 1300 comprises a processor or processing circuitry 1302, and may comprise a memory 1304 and interfaces 1306. The processing circuitry 1302 is operable to perform some or all of the steps of the method 500 and/or 600 as discussed above with reference to FIGS. 5 and 6. The memory 13204 may contain instructions executable by the processing circuitry 1302 such that the distributed node 1300 is operable to perform some or all of the steps of the method 500 and/or 600. The instructions may also include instructions for executing one or more telecommunications and/or data communications protocols. The instructions may be stored in the form of the computer program 1350. In some examples, the processor or processing circuitry 1302 may include one or more microprocessors or microcontrollers, as well as other digital hardware, which may include digital signal processors (DSPs), special-purpose digital logic, etc. The processor or processing circuitry 1302 may be implemented by any type of integrated circuit, such as an Application Specific Integrated Circuit (ASIC), Field Programmable Gate Array (FPGA) etc. The memory 1304 may include one or several types of memory suitable for the processor, such as read-only memory (ROM), random-access memory, cache memory, flash memory devices, optical storage devices, solid state disk, hard disk drive etc.

FIG. 14 illustrates functional units in another example of distributed node 1400 which may execute examples of the methods 500 and/or 600 of the present disclosure, for example according to computer readable instructions received from a computer program. It will be understood that the units illustrated in FIG. 14 are functional units, and may be realised in any appropriate combination of hardware and/or software. The units may comprise one or more processors and may be integrated to any degree.

Referring to FIG. 14, the distributed node comprises a communication module 1402 for receiving a seed version of a machine-learning model, wherein the seed version of the machine-learning model has been developed using a machine-learning algorithm. The distributed node further comprises a data module 1404 for generating a representation of distribution of data within a local data set associated with the distributed node. The communication module 1402 is also for communicating the generated representation to a management function. The distributed node 1400 further comprises a learning module 1406 for developing a node version of the machine-learning model, based on the seed version of the machine-learning model and the associated local data set, and using the machine-learning algorithm. The communication module is also for communicating a representation of the node version of the machine-learning model to the management function. The distributed node 1400 may also comprise interfaces 1408.

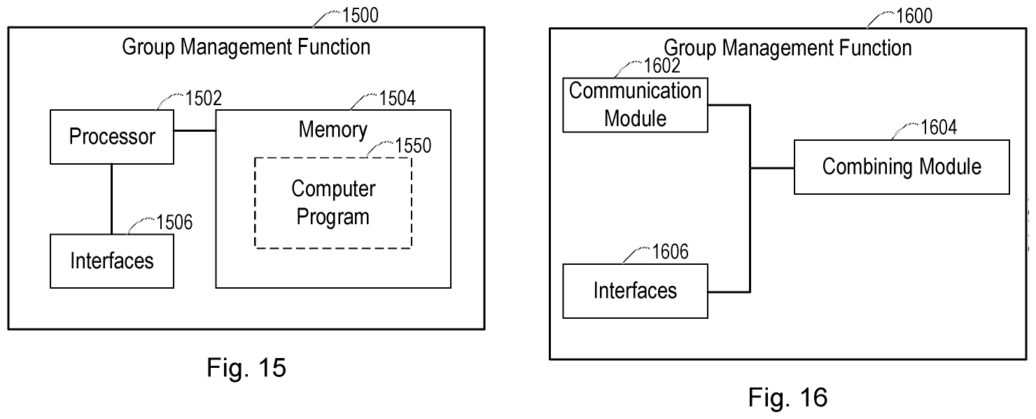

FIG. 15 is a block diagram illustrating an example group management function 1500 which may implement the method 700 and/or 800 according to examples of the present disclosure, for example on receipt of suitable instructions from a computer program 1550. Referring to FIG. 15, the group management function 1500 comprises a processor or processing circuitry 1502, and may comprise a memory 1504 and interfaces 1506. The processing circuitry 1502 is operable to perform some or all of the steps of the method 700 and/or 800 as discussed above with reference to FIGS. 7 and 8. The memory 1504 may contain instructions executable by the processing circuitry 1502 such that the group management function 1500 is operable to perform some or all of the steps of the method 700 and/or 800. The instructions may also include instructions for executing one or more telecommunications and/or data communications protocols. The instructions may be stored in the form of the computer program 1550. In some examples, the processor or processing circuitry 1502 may include one or more microprocessors or microcontrollers, as well as other digital hardware, which may include digital signal processors (DSPs), special-purpose digital logic, etc. The processor or processing circuitry 1502 may be implemented by any type of integrated circuit, such as an Application Specific Integrated Circuit (ASIC), Field Programmable Gate Array (FPGA) etc. The memory 1504 may include one or several types of memory suitable for the processor, such as read-only memory (ROM), random-access memory, cache memory, flash memory devices, optical storage devices, solid state disk, hard disk drive etc.

FIG. 16 illustrates functional units in another example of group management function 1600 which may execute examples of the methods 700 and/or 800 of the present disclosure, for example according to computer readable instructions received from a computer program. It will be understood that the units illustrated in FIG. 16 are functional units, and may be realised in any appropriate combination of hardware and/or software. The units may comprise one or more processors and may be integrated to any degree.

Referring to FIG. 16, the management function 1600 comprises a communication module 1602 for receiving, from distributed nodes in the learning group, representations of node versions of a machine-learning model, wherein the node versions of the machine-learning model have been developed based on a seed version of the machine-learning model and a local data set associated with the respective distributed node, and using a machine-learning algorithm. The group management function 1600 further comprises a combining module 1604 for combining the node versions of the machine-learning model to form a group version of the machine learning model. The communication module 1602 is also for communicating the group version of the machine-learning model to a centralized management function. The group management function 1600 may also comprise interfaces 1606.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-7. (canceled)

8. A method for using federated learning to develop a machine-learning model, the method, performed by a management function, comprising:
developing a seed version of the machine-learning model using a machine-learning algorithm;
communicating the seed version of the machine-learning model to a plurality of distributed nodes, each of the plurality of distributed nodes being associated with a local data set;
receiving, for each of the plurality of distributed nodes, a representation of distribution of data within the associated local data set;
assigning each of the plurality of distributed nodes to a learning group on the basis of the received representations, wherein each learning group comprises a subset of the plurality of distributed nodes amongst which federated learning is to be performed; and
obtaining at least one group version of the machine learning model for each learning group based on the node versions of the machine learning model developed by the distributed nodes in the learning group.

9. The method of claim 8, wherein obtaining at least one group version of the machine learning model for each learning group based on the node versions of the machine learning model developed by the distributed nodes in the learning group comprises receiving the at least one group version of the machine learning model for each learning group from a group management function of the respective learning group.

10. The method of claim 8, further comprising, for each learning group:
instantiating a group management function for the learning group; and
instructing distributed nodes in the learning group to communicate representations of node version of the machine-learning model to the instantiated group management function.

11. The method of claim 8, further comprising developing an updated seed version of the machine-learning model based on the obtained group versions of the machine-learning model.

12. The method of claim 8, wherein the management function comprises a centralized management function, and a distributed management function, and wherein the distributed management function comprises a group management function for each learning group.

13. The method of claim 12, wherein the step of obtaining the at least one group version of the machine learning model for each learning group comprises:
generating the at least one group version of the machine learning model for each learning group at the distributed management function; and
communicating the group versions of the machine learning model from the distributed management function to the centralized management function.

14. The method of claim 13, wherein the step of obtaining the at least one group version of the machine learning model for each learning group comprises, for each learning group:
obtaining, at a group management function for the group, a node version of the machine-learning model from each distributed node of the respective learning group, wherein the node version of the machine-learning model has been developed based on the seed version of the machine-learning model and a local data set associated with the respective distributed node, and using the machine-learning algorithm;
combining, at the group management function, the obtained node versions of the machine-learning model to form a group version of the machine learning model for that learning group; and
communicating, by the group management function, the group version of the machine learning model for that learning group to the centralized management function.

15. The method of claim 12, further comprising instructing the plurality of distributed nodes to communicate a representation of a node version of the machine-learning model, wherein the node version of the machine-learning model has been developed based on the seed version of the machine-learning model and a local data set associated the respective distributed node, and using the machine-learning algorithm.

16. The method of claim 15, wherein the step of instructing the each of the plurality of distributed nodes to communicate a representation of a node version of the machine-learning model comprises instructing the each of the plurality of distributed nodes to communicate a representation of a node version of the machine-learning model to a respective one of the group management functions in the distributed management function.

17. The method of claim 8, wherein
the representation of distribution of data within the local data set comprises any one of a Gaussian mixture model (GMM), a Euclidean distance, a L-2 distance, a maximum mean discrepancy (MMD), or a Jsensen-Renyi divergence, and
the representation of distribution of data within the local data set further comprises a quantity of labels per predetermined category in the local data set.

18. (canceled)

19. The method of claim 8, further comprising:
designing at least one hyper parameter for distributed nodes in a learning group using the representation of distribution of data within the local data set for distributed nodes assigned to the learning group; and
communicating the designed at least one hyper parameter to distributed nodes assigned to the learning group.

20. The method of claim 8, wherein the plurality of distributed nodes are assigned to a learning group on the basis of the similarity of the received representations of distribution of data.

21. The method of claim 8, wherein assigning each of the plurality of distributed nodes to a learning group on the basis of the received representations comprises comparing received representations of distribution of data within the local data sets with a representation of distribution of data in a reference data set that is available to the management function.

22. The method of claim 8, wherein developing a seed version of the machine-learning model comprises combining representations of node versions of the machine-learning model received form distributed nodes.

23. A method for using federated learning to develop a machine-learning model, the method, performed by a distributed node, comprising:
receiving a seed version of a machine-learning model, wherein the seed version of the machine-learning model has been developed using a machine-learning algorithm;
generating a representation of distribution of data within a local data set associated with the distributed node;
communicating the generated representation to a management function;
developing a node version of the machine-learning model, based on the seed version of the machine-learning model and the associated local data set, and using the machine-learning algorithm; and
communicating a representation of the node version of the machine-learning model to the management function.

24. The method of claim 23, wherein
the representation of distribution of data within the local data set comprises any one of a Gaussian mixture model (GMM), a Euclidean distance, a L-2 distance, a maximum mean discrepancy (MMD), or a Jsensen-Renyi divergence and
the representation of distribution of data within the local data set further comprises a quantity of labels per predetermined category in the local data set.

25. (canceled)

26. The method of claim 23, further comprising:
receiving form the management function at least one hyper parameter that is designed for a learning group to which the distributed node is assigned; and
using the hyper parameter to develop a node version of the machine-learning model.

27. The method of claim 23, wherein the distributed node is assigned to a learning group on the basis of a similarity of its representations of distribution of data to representations of distribution of data in local data sets associated with other distributed nodes.

28. The method of claim 23, wherein
the step of communicating the representation of the node version of the machine-learning model to the management function comprises communicating the representation of the node version of the machine-learning model to a group management function of a learning group to which the distributed node is assigned, and
the method further comprises receiving, from the management function, an instruction of how to communicate a representation of the node version of the machine-learning model to the management function.

29. (canceled)

30. A method for using federated learning to develop a machine-learning model, the method, performed by a group management function for a learning group, comprising:
receiving, from distributed nodes in the learning group, representations of node versions of a machine-learning model, wherein the node versions of the machine-learning model have been developed based on a seed version of the machine-learning model and a local data set associated with the respective distributed node, and using a machine-learning algorithm;
combining the node versions of the machine-learning model to form a group version of the machine learning model; and
communicating the group version of the machine-learning model to a centralized management function.

31. The method of claim 30, wherein the distributed nodes in the learning group have been assigned to the learning group on the basis of the similarity of representations of distribution of the local data set associated with each distributed node.

32. A non-transitory computer readable storage medium storing a computer program comprising instructions which, when executed on at least one processor, cause the at least one processor to perform the method of claim 1.

33-34. (canceled)

35. A management function for using federated learning to develop a machine-learning model, the management function comprising processing circuitry configured to cause the management function to:
develop a seed version of the machine-learning model using a machine-learning algorithm;
communicate the seed version of the machine-learning model to a plurality of distributed nodes, each of the plurality of distributed nodes being associated with a local data set;
receive, for each of the plurality of distributed nodes, a representation of distribution of data within the associated local data set;
assign each of the plurality of distributed nodes to a learning group on the basis of the received representations, wherein each learning group comprises a subset of the plurality of distributed nodes amongst which federated learning is to be performed; and
obtain at least one group version of the machine learning model for each learning group based on the node versions of the machine learning model developed by the distributed nodes in the learning group.

36-38. (canceled)

39. A distributed node for using federated learning to develop a machine-learning model, the distributed node comprising processing circuitry configured to cause the distributed node to:
receive a seed version of a machine-learning model, wherein the seed version of the machine-learning model has been developed using a machine-learning algorithm;
generate a representation of distribution of data within a local data set associated with the distributed node;
communicate the generated representation to a management function;
develop a node version of the machine-learning model, based on the seed version of the machine-learning model and the associated local data set, and using the machine-learning algorithm; and
communicate a representation of the node version of the machine-learning model to the management function.

40-42. (canceled)

43. A group management function for using federated learning to develop a machine learning model, the group management function comprising processing circuitry configured to cause the group management function to:
receive, from distributed nodes in the learning group, representations of node versions of a machine-learning model, wherein the node versions of the machine-learning model have been developed based on a seed version of the machine-learning model and a local data set associated with the respective distributed node, and using a machine-learning algorithm;
combine the node versions of the machine-learning model to form a group version of the machine learning model; and
communicate the group version of the machine-learning model to a centralized management function

44-46. (canceled)
